(19) United States
(12) Patent Application Publication
(10) Pub. No.: US 2010/0061895 A1
(43) Pub. Date: Mar. 11, 2010

(54) APPARATUS FOR THE PRODUCTION OF SILICON FROM MELT WITH INDICATION OF MELT SPILL AND MELT-SPILL ALARM SYSTEM

(76) Inventors: Sergii Beringov, Kiev (UA); Stanislav Kulikovskyi, Kiev (UA); Valeriy Ylisyeyv, Kiev (UA); Victor Kravchenko, Kiev (UA)

Correspondence Address: WEINER & BURT, P.C., 635 N US-23, POB 186, HARRISVILLE, MI, 48740, US

(21) Appl. No.: 12/597,753

(22) PCT Filed: Apr. 24, 2008
(86) PCT No.: PCT/UA08/00025

§ 371 Date: Oct. 27, 2009

(30) Foreign Application Priority Data
Apr. 27, 2007 (UA) A2007 04746

(51) Int. Cl. G01M 3/16; G08B 21/00

(52) U.S. Cl. 422/119

(57) ABSTRACT

This invention relates to devices useful in the production of silicon from a melt. According to the invention there is provided an apparatus for the production of silicon from a melt with an indication of a melt spill, the apparatus comprising a crucible for producing a molten material, a susceptor for the crucible, and a melt-spill indicator comprising four leakage sensors. The susceptor for the crucible has four openings, each for accommodating a guiding rod, and each leakage sensor is composed of two electrodes, one of which being bowl-shaped and arranged under a respective guiding rod. The apparatus has a warning device for giving a warning of the melt spill. The apparatus of the invention provides for conditions of crystallization of polycrystalline silicon with any melt leakage adequately detected.

### TECHNICAL FIELD

This invention relates to devices useful in the production of silicon from a melt and can be used in the manufacture of semiconductor converters of solar energy, particularly polycrystalline silicon solar cells.

### BACKGROUND ART

Multicrystalline silicon is prepared from a melt with oriented crystallization. Polycrystalline silicon is melted in a crucible by heating it with the help of a heater, while oriented crystallization is achieved by heat-removal from the bottom portion of the melt. Multicrystalline silicon is much lower in cost and far easier to produce than monocrystalline silicon. As multicrystalline silicon has monocrystalline grains of a size from some millimeters to some centimeters , multicrystalline silicon is used in the manufacture of solar cells as effectively as monocrystalline silicon.

Preparation of a silicon ingot is a high-temperature and lengthy process and hence, during the melting process, it is possible that the silicon melt would leak and spill from the crucible. With great amounts of the raw material charged in the crucible, which is characteristic of the polycrystalline silicon production, any spill of the silicon melt is harmful to the operators, is wasteful of silicon and resulting in making costly equipment inoperative.

Known in the art are devices for catching the silicon melt leaked from the crucible, such devices as disclosed in U.S. Pat. No. 6,605,152 (Int. Cl. C30B 36/00, issued Dec. 08, 2003) [1] and U.S. Pat. No. 6,348,870 (Int. Cl. G08B 21/00, issued Feb. 19, 2002) [2] and used in the production of monocrystalline silicon by the Czochralski method.

A crystal growth apparatus with a melt-spill indicator is the closest prior art and is disclosed in U.S. Pat. No. 6,348,870 [2] as comprising a crucible for producing a molten material, a susceptor for the crucible, and a melt-spill indicator electrically connected to a warning device. The susceptor for the crucible has a bowl-shaped form and supports the crucible. The susceptor is supported by a susceptor cup. The susceptor is composed of two ladle-shaped parts, which are held together by the susceptor cup. The melt-spill indicator is arranged between the bottom portion of the susceptor and the susceptor cup and comprises three plates of insulative material separated by two conductor pads.

A melt-spill alarm system also bearing closely on the invention is disclosed in U.S. Pat. No. 6,348,870 [2] as comprising a melt-spill indicator electrically connected to a warning device. The melt-spill indicator comprises three plates of insulative material separated by two conductor pads.

The prior art crystal growth apparatus and melt-spill alarm system are used in the production of monocrystalline silicon by the Czochralski method where the amount of the raw material loaded into the crucible is relatively small (typically 125 kilograms) or the raw material is loaded in smaller amounts than the crucible capacity. The production of polycrystalline silicon in such apparatus is impossible because oriented crystallization in the bottom portion and hence the growth of polycrystals will be upset. Also, in the production of a polycrystalline silicon ingot, the crucible is loaded to capacity; therefore pieces of silicon may fall out the crucible and trigger a spurious alarm.

### DISCLOSURE OF THE INVENTION

The present invention aims to provide an improved apparatus for the production of silicon from a melt with an indication of a melt spill wherein crystallization of polycrystalline silicon will be made possible and any melt leakage will be adequately detected owing to the construction as claimed and described.

The present invention also aims to provide an improved melt-spill alarm system wherein any melt leakage will be detected in the process of producing polycrystalline silicon with oriented crystallization owing to the combination of features as claimed and described.

According to the invention there is provided an apparatus for the production of silicon from a melt with an indication of a melt spill, the apparatus comprising a crucible for producing a molten material, a susceptor for the crucible, and a melt-spill indicator electrically connected to a warning device, and wherein the melt-spill indicator comprises four leakage sensors, the susceptor for the crucible comprises four side plates and a bottom plate having four openings. In this case, each of the side plates on the lower portion of the inner side thereof has a guiding face extending toward a respective opening via at least one groove, each opening accommodates a guiding rod, and each leakage sensor is composed of two electrodes, one of which being bowl-shaped and arranged under a respective guiding rod.

According to the invention there is also provided a melt-spill alarm system comprising a melt-spill indicator electrically connected to a warning device, and wherein the melt-spill indicator comprises four leakage sensors, each being composed of two electrodes, one of which being bowl-shaped for collecting any melt leakage and the other being electrically connected to the warning device, which comprises a light alarm and an audible alarm.

It has been found experimentally that constructional features of the apparatus for the production of silicon from a melt, such as the side plates of the susceptor having guiding faces, the guiding rods arranged in the openings of the susceptor bottom plate, and the melt-spill indicator comprising four leakage sensors arranged under the guiding rods, had provided for such heat-exchange conditions that allow oriented crystallization of polycrystalline silicon with melt leakage detection possible.

### BRIEF DESCRIPTION OF DRAWINGS

The invention is further illustrated by the accompanying drawings, though not limited by them, in which:

FIG. 1 is a view in cross-section of an apparatus for the production of silicon from a melt with an indication of a melt spill together with a melt-spill alarm system;

FIG. 2 is a schematic representation of the melt-spill alarm system;

### BEST MODE FOR CARRYING OUT THE INVENTION

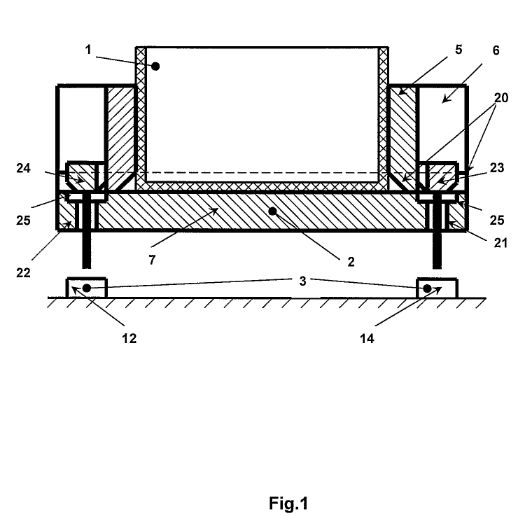

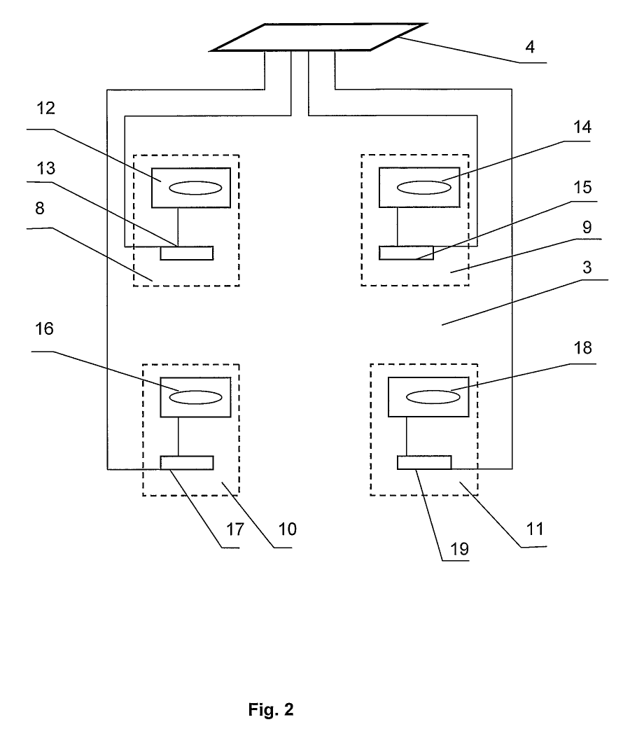

The apparatus for the production of silicon from a melt with an indication of a melt spill comprises a crucible 1, square in cross-section, for producing a molten material, a susceptor 2 for the crucible, and a melt-spill indicator 3 (shown in more detail in FIG. 2) electrically connected to a warning device 4. Like the crucible 1, the susceptor 2 for the crucible is square in cross-section and comprises four side plates, two of which designated 5 and 6 being shown in FIG. 1, and a bottom plate 7. The melt-spill indicator 3 (FIG.) comprises four leakage sensors 8, 9, 10, and 11, each being composed of two electrodes 12 and 13; 14 and 15; 16 and 17; 18 and 19. One electrode designated 12, 14, 16, and 18 of each sensor has a bowl-shaped form. The electrodes 13, 15, 17, and 19 are embedded via gas-insulated bushings (not shown) in the bottom of an electric furnace and electrically connected to the warning device 4 so that each sensor 8, 9, 10, and 11 would complete its respective electric circuit with the warning device 4. Each of the side plates of the susceptor 2 has a guiding face 20 on the inner side thereof as can be seen in FIG. 1. In the bottom plate 7 of the susceptor 2, there are four openings, two of which designated 21 and 22 being shown in FIG. 1. A guiding rod is arranged in each opening. Guiding rods 23 and 24 are shown in FIG. 1 as arranged in the openings 21 and 22 respectively. The guiding face of each side plate extends toward a respective opening through at least one groove. As shown in FIG. 1, the guiding face 20 extends toward the opening 22 through the groove 25. Each of the bowl-shaped electrodes 12, 14, 16, and 18 is arranged under a respective guiding rod and adapted to receive molten silicon that would flow down the guiding rod, and is coupled conductively with the electric furnace structure. FIG. 1 shows the bowl-shaped electrodes 12 and 14, which are arranged under the guiding rods 23 and 24. The warning device comprises light alarms, for example, three light alarms (light-emitting diodes) such as yellow, green, and red. There is also an audible alarm (not shown).

The apparatus for the production of silicon from a melt with an indication of a melt spill operates as follows.

The crucible 1 is loaded with a raw material comprising polycrystalline silicon and poly- and/or polycrystalline silicon production residue as a recycled material, and then the process of melting is performed to be followed by oriented crystallization with heat-removal.

Under normal operation of the crucible 1 and without any spill or leakage of the silicon melt, there is nothing in the bowl-shaped electrodes 12, 14, 16, and 18, and the electrical circuit of each of the sensors 8, 9, 10, and 11 is open. In this situation, electrical resistance of each circuit of each sensor 8, 9, 10, and 11 being more than 500 Ω, the yellow light alarm is switched on and the audible alarm is switched off.

When a piece of the raw material comes in contact with the bowl-shaped electrode, electrical resistance of each circuit of each sensor 8, 9, 10, and 11 may be in the range of 500 Ω to 50 Ω and the green light alarm of the warning device 4 is switched on. The audible alarm is switched off.

If a breakage of the crucible 1 occurs, silicon melt flows out and by way of example flows down the guiding faces (20), grooves (25) and through respective openings (22) onto the rods (24). The silicon melt further flows into the bowl-shaped electrode (14) of the respective sensor (9). The bowl-shaped electrode (14) is filled with the silicon melt, the electrical resistance of the sensor (9) drops. When the electrical resistance drops below 50 Ω, the respective light alarm of the warning device 4 becomes red, the audible alarm is switched on. Where at least one of the four sensors indicates the circuit resistance that is lower than 50 Ω, the state of that electrical circuit is checked with a multimeter. When at least one more sensor operates, steps are taken to stop the leakage.

Thus, the apparatus for the production of silicon from a melt with an indication of a melt spill and giving warning of the melt spill provides for conditions of crystallization of polycrystalline silicon with any melt leakage adequately detected.

1. An apparatus for the production of silicon from a melt with an indication of a melt spill, the apparatus comprising a crucible for producing a molten material, a susceptor for the crucible, and a melt-spill indicator electrically connected to a warning device, and characterized in that the melt-spill indicator comprises four leakage sensors, the susceptor for the crucible comprises four side plates and a bottom plate having four openings, each of the side plates on the lower portion of the inner side thereof having a guiding face extending toward a respective opening via at least one groove, each opening accommodating a guiding rod, and each leakage sensor being composed of two electrodes, one of which being bowl-shaped and arranged under a respective guiding rod.

2. A melt-spill alarm system comprising a melt-spill indicator electrically connected to a warning device, and characterized in that the melt-spill indicator comprises four leakage sensors, each being composed of two electrodes, one of which being bowl-shaped for collecting any melt leakage and the other being electrically connected to the warning device.

3. The system of claim 2 characterized in that the warning device comprises a light alarm and an audible alarm.
